(19) United States
(12) Patent Application Publication
(10) Pub. No.: US 2023/0075425 A1
(43) Pub. Date: Mar. 9, 2023

(54) SYSTEMS AND METHODS FOR TRAINING AND USING MACHINE LEARNING MODELS AND ALGORITHMS

(71) Applicant: Argo AI, LLC, Pittsburgh, PA (US)

(72) Inventors: Thomas Muehlenstaedt, Markt Schwaben (DE); Jelena Frtunikj, München (DE)

(21) Appl. No.: 17/465,398

(22) Filed: Sep. 2, 2021

(51) Int. Cl. G06N 20/00; G06K 9/62

(52) U.S. Cl. CPC G06N 20/00; G06K 9/623

(57) ABSTRACT

Systems and methods for training a machine learning model. The methods comprise, by a computing device: obtaining a training data set comprising a collection of training examples, each training example comprising data point(s); selecting a first subset of training examples from the collection of training examples based on at least one of a derivative vector of a loss function for each training examples in the collection of training examples and an importance of each training example relative to other training examples of the collection of training examples; and training the machine learning model using the first subset of training examples. A total number of training examples in the first subset of training examples is unequal to a total number of training examples in the collection of training examples.

### BACKGROUND

### Statement of the Technical Field

The present disclosure relates generally to machine learning systems. More particularly, the present disclosure relates to implementing systems and methods for training and/or using machine learning models and algorithms.

### Description of the Related Art

Modern day vehicles have at least one on-board computer and have internet/satellite connectivity. The software running on these on-board computers monitor and/or control operations of the vehicles. The vehicle also comprises cameras, radars and LiDAR sensors for detecting objects in proximity thereto. The cameras capture images of the scenes in proximity to the vehicles. The LiDAR detectors generate LiDAR datasets that measure the distance from the vehicle to the objects at a plurality of different times. These images and distance measurements can be used by machine learning models and/or algorithms for identifying objects, tracking movements of the object, making predictions as to the object's trajectory, and planning paths of travel for the vehicle based on the predicted objects trajectory.

### SUMMARY

The present disclosure concerns implementing systems and methods for training and/or using a machine learning model or algorithm. The methods comprise: obtaining, by a computing device, a training data set comprising a collection of training examples (each training example comprising data point(s) (e.g., pixel values from an image or values of other sensor data) and a true value for a property to be predicted by the machine learning model/algorithm); selecting, by the computing device, a first subset of training examples from the collection of training examples based on, for example, at least one of a derivative vector of a loss function for each training example of the collection of training examples and an importance of each training example relative to other training examples; training, by the computing device, the machine learning model/algorithm using the first subset of training examples; and/or using the machine learning model/algorithm which has been trained to control operations of a mobile platform (e.g., an autonomous vehicle, articulating arm or other robotic device). A total number of training examples in the first subset of training examples is unequal to a total number of training examples in the collection of training examples. In this way, a portion of the training examples in the training data set are used to train the machine learning model/algorithm.

In some scenarios, the first subset of training examples is selected based on norms of derivative vectors of the loss function. Each derivative vector is determined for a respective training example of the collection of training examples contained in the training data set. For example, the training examples can be ranked in accordance with the norms of the derivative vectors of the loss function associated therewith. A given number of training examples with the best rankings are selected for inclusion in the first subset of training examples. All other training examples of the training data set are excluded from the first subset of training examples.

In those or other scenarios, the methods also comprise: selecting, by the computing device, a second subset of training examples based on at least one of a derivative vector of the loss function for each training example of the collection of training examples and an importance of each training example relative to the other training examples. The first subset of training examples is used in a first epoch of the training process and the second subset of data points is used in a second epoch of the training process. A total number of training examples in the second subset is different than (e.g., greater than) the total number of training examples in the first subset.

Implementing systems of the above-described methods for image-based perception and can include, but are not limited to, a processor and a non-transitory computer-readable storage medium comprising programming instructions that are configured to cause the processor to implement a method for training and/or using a machine learning model or algorithm.

### BRIEF DESCRIPTION OF THE DRAWINGS

The present solution will be described with reference to the following drawing figures, in which like numerals represent like items throughout the figures.

FIG. 1 is an illustration of a system.

FIG. 2 is an illustration of an architecture for a vehicle.

FIG. 3 is an illustration of an architecture for a computing device.

FIG. 4 provides a flow diagram of an illustrative method for improved machine learning optimization.

FIG. 5 provides a graph that is useful for understanding the method of FIG. 4.

FIG. 6 provides a flow diagram that is useful for understanding an illustrative method in which a trained machine learning model and/or algorithm is employed.

FIG. 7 provides a block diagram that is useful for understanding how a robotic system (e.g., an autonomous vehicle) is controlled in accordance with the present solution.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.” Definitions for additional terms that are relevant to this document are included at the end of this Detailed Description.

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

The term “spatial feature map” as used herein refers to a spatial-relational construct of an object. The spatial feature map is output from a function that converts or otherwise transforms a feature vector in one space (e.g., an image domain) into a feature vector in another space (e.g., a high-dimensional domain). For example, the function can return a spatial feature map comprising [a first detected feature identifier, a first detected feature classification, a first detected feature location in an image, a strength of a link from the first detected feature to a real object, a second feature identifier, a second detected feature classification, a second feature location in an image, a strength of a link from the second detect feature to the real object, . . . ] from an input vector [a first pixel identifier, a first pixel location, a first pixel color, a second pixel identifier, a second pixel location, a second pixel color, . . . ]. Each strength value of the spatial feature map can comprise a probabilistic strength of relation between the feature and a certain detected object (e.g., vehicle, pedestrian, bicycle, dog, etc.) in an image.

Machine learning models and/or algorithms can be used in various applications. For example, machine learning models and/or algorithms can be employed in image-based machine learning systems. Such image-based machine learning systems can be implemented in robotic systems (e.g., autonomous vehicles and articulating arms). The robotic systems may use the machine learning models and/or algorithms for various purposes such as feature extraction using multi-camera views to perform perception feature fusion for cuboid association using loss functions that iteratively process data points over multiple cycles.

In feature extraction scenarios, the machine learning models and/or algorithms may be trained to facilitate generation of spatial feature maps using captured images. The machine learning models and/or algorithms can include, but are not limited to, Convolutional Neural Networks (CNNs) and/or Recurrent Neural Networks (RNNs). Images may be input into trained CNN(s) and RNNs to produce output spatial feature maps. Each trained CNN/RNN takes a Red Green Blue (RGB) image as an input, and optionally outputs one or more predictions such as the class of the 2D image (e.g., a person, a vehicle, a cyclist, a dog, etc.). The class of the image is determined based on learned data patterns during training of the CNN/RNN. Each spatial feature map indicates a location and a strength of each detected feature in an image. The features can include, but are not limited to, edges, vertical lines, horizontal lines, bends and/or curves. A certain combination of features in a certain area of an image can indicate that a larger, more complex feature may exist in the image. For example, a spatial feature map could detect a cyclist from a combination of line features and circle features in an area of an image.

The machine learning models and/or algorithms are trained in accordance with a novel process. For example, a machine learning model f_{θ}(x) is trained with a training data set comprising a collection of training examples (x₀, y₀), (x₁, y₁), . . . , (xₙ, yₙ), where each component x₀, x₁, . . . , xₙ represents a sensor output (e.g., an image) comprising a collection of data points d₁, d₂, . . . , dᵣ (e.g., pixel values for the image) and each component y₀, y₁, . . . , yₙ represents a label or ground truth. n and r are integers. The terms “label” and “ground truth” as used here both refer to a true value for a property to be predicted (e.g., a type of object (such as a cyclist), a 3D size of an object (e.g., a predicted cuboid) or a position of the object in an image) by the machine learning models/algorithms. The training process generally involves processing the training examples iteratively during a plurality of epochs e₁, e₂, . . . , e_{w} of a training process. w is an integer.

The term “epoch” as used herein in relation to conventional training processes refers to a period of time in which a full collection of training examples (x₀, y₀), (x₁, y₁), . . . , (xₙ, yₙ) is processed during the training of a machine learning model/algorithm. i is an integer equal to or greater than zero. In contrast, the term “epoch” as used herein in relation to the present solution refers to a period of time in which a subset of the training examples (xᵢ, yᵢ) is processed during the training of a machine learning model/algorithm for optimizing a loss function, where the subset comprises less than all of the training examples (x₀, y₀), (x₁, y₁), . . . , (xₙ, yₙ) of the training data set. The importance of the difference in these definitions for epoch will become evident as the discussion progresses.

In each such epoch of a conventional training process, all training examples of a training data set are iterated through to optimize a loss function l(yᵢ, f_{θ}(xᵢ)). This iterative process may be costly, resource intensive and time consuming because the number of training examples n that are processed can be large (e.g., >1e6). In such conventional solutions, the training of a specific machine learning model/algorithm can take a relatively long amount of time (e.g., hours or days) on expensive and energy intensive equipment. This is undesirable in some applications.

The present solution provides a novel training process for machine learning models/algorithms with a reduced computation time, less resource intensity and/or an equivalent or improved loss function between observed and predicted outputs. The novel training process of the present solution involves obtaining a training data set (x₀, y₀), (x₁, y₁), . . . , (xₙ, yₙ). The training data set can be created using image(s) or other sensor data generated by one or more sensor(s) (e.g., cameras and/or LiDAR systems) on a mobile platform (e.g., an autonomous vehicle). The labels or ground truth values yᵢ may be manually defined for each data point xᵢ.

Next, a derivative vector θ of a loss function l_{θ}(x) is determined for each training example (xᵢ, yᵢ). Techniques for determining a derivative vector of a loss function are well known. In some scenarios, the loss function l_{θ}(x) generally involves comparing a true value yᵢ with a predicted value yₚ to obtain an output representing a distance D (e.g., a Euclidean distance) between the true value yᵢ and the predicted value yₚ. The distance D output from performance of the loss function l_{θ}(x) should be small. The derivative vector θ is randomly initialized for use in a first epoch e₀ in which a first subset of training examples are analyzed, and changed over all epochs e₁, . . . , e_{w} for the other subsets of training examples to iteratively improve the output of the loss function. The derivative vector θ may be changed in accordance with a known backpropagation algorithm in the direction of the derivative for the loss function (i.e., the direction of the steepest descent of the loss function). The backpropagation algorithm generally computes the gradient of the loss function with respect to the weights of the neural network for a set of input-output training examples, often called a training batch.

The norms of the derivative vectors θ may then be used to select a subset sᵢ of the training examples in a training data set that should be used in an epoch of the training process. The importance of each training example relative to the other training examples in a given training data set may additionally or alternatively be used to select the training examples to be contained in the subset sᵢ. The subsets of training examples sᵢ are then used in the plurality of epochs e₀, e₁, . . . , e_{w} to train a machine learning model or algorithm. The importance of each training example can be based on, for example, an uncertainty of each training example given the other training examples in the training data set, a confidence score for the label of the training example, types of features that data points in a training example are associated with (e.g., a line, curve, etc.), sizes of the features, and/or relative locations of features.

The training example subset selection process is performed such that a total number of training examples in a subset for first epoch(s) (e.g., epochs e₀, e₁, . . . , e₅) is different (e.g., is less) than the total number of training examples in subsets for subsequent second epoch(s) (e.g., epochs e₆, e₇, . . . , e₂₀). The total number of training examples may be increased or otherwise varied for subsequent epochs. For example, five percent of the total training examples of a training data set are to be used in a first epoch e₀, while twenty percent of the total training examples of the training data set are to be used in a second subsequent epoch e₁, . . . , or e_{w}. These percentages can be predefined or dynamically determined based on a total number of training examples in the training data set and/or a confidence value associated with a label of each training example (e.g., reflecting the accuracy of the data).

The training examples of the training data set may be selected for inclusion in a subset sᵢ based on their rankings. The training examples can be ranked in accordance with the norms of their derivative vectors. The training examples with the greatest or best rankings are then selected for inclusion in the subset sᵢ. For example, M training examples of the training data set are selected which have the greatest or best ranking, and therefore are contained in a subset s₁. N training examples are selected which have the greatest or best ranking, and therefore are contained in a subset s₂. N may be the same as or different than M. In effect, only a subset of the training examples is used in each epoch as compared to prior art systems which use all training examples in every epoch. This feature of the present solution reduces computational time of the training process.

The above described training process has a reduced training time without compromising interference performance and many novel features. The novel features include, but are not limited to, the dynamic use of training data depending on the importance thereof and the production of side effect information about the training examples by collecting the derivative information per training example.

The present solution will be described below in the context of an autonomous vehicle application. The present solution is not limited to autonomous vehicle applications. The present solution can be used in other applications such as other robotic applications (e.g., to control an articulating arm).

### Illustrative Implementing Systems

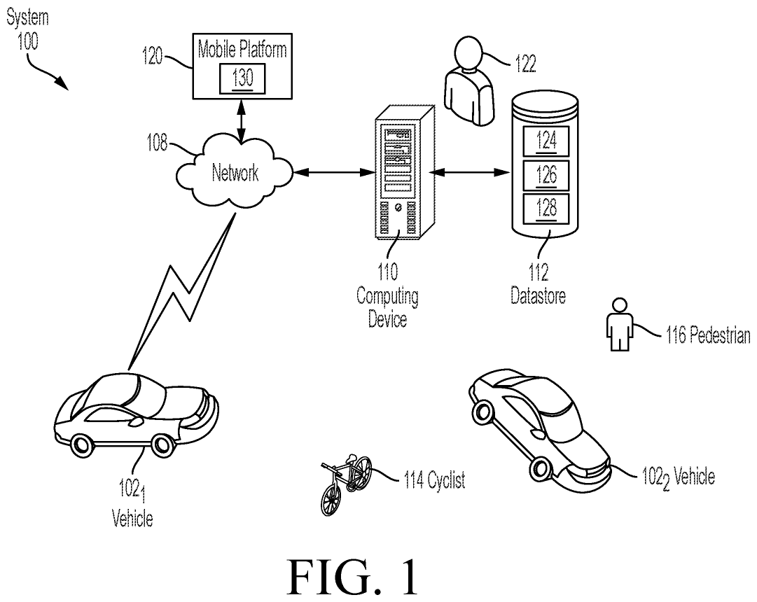

Referring now to FIG. 1, there is provided an illustration of an illustrative system 100 implementing the present solution. System 100 comprises a mobile platform 120 communicatively coupled to a computing device 110 via a network 108 (e.g., the Internet and/or cellular network). The mobile platform 120 is configured to generate sensor data 124. The mobile platform can include, but is not limited to, a land vehicle (as shown in FIG. 1), an aircraft, a watercraft, a subterrene, or a spacecraft. The sensor data 124 can include, but is not limited to, images and/or LiDAR datasets. The sensor data 124 is communicated from the mobile platform 120 to the computing device 110 for processing and/or storage in datastore 112.

A user 122 of the computing device 110 can perform user-software interactions to access the sensor data 124 and use the sensor data to generate training data sets 126 for machine learning model(s) or algorithm(s) 128. Each training data set 126 comprises a plurality of training examples (x₀, y₀), (x₁, y₁), . . . , (xₙ, yₙ). The user 122 can manually define the labels or ground truth values yᵢ for each data set xᵢ. The training data set 126 is then stored in datastore 112 (e.g., a database) and/or used by the computing device 110 during a training process to train the machine learning model(s)/algorithm(s) 128 to, for example, facilitate scene perception by another mobile platform using loss functions that iteratively process training examples over multiple cycles. The scene perception can be achieved via feature extraction using multi-camera views, object detection using the extracted features and/or object prediction (e.g., predicted cuboids and associations of predicted cuboids with detected objects). The training process will be described in detail below.

Once trained, the machine learning model(s)/algorithm(s) 128 is(are) deployed on the other mobile platforms such as vehicle 102₁. Vehicle 102₁ can travel along a road in a semi-autonomous or autonomous manner. Vehicle 102₁ is also referred to herein as an Autonomous Vehicle (AV). The AV 102₁ can include, but is not limited to, a land vehicle (as shown in FIG. 1), an aircraft, a watercraft, a subterrene, or a spacecraft. AV 102₁ is generally configured to use the trained machine learning model(s)/algorithm(s) 128 to detect objects 102₂, 114, 116 and perceive scenes in proximity thereto. The objects can include, but are not limited to, a vehicle 102₂, a cyclist 114 (such as a rider of a bicycle, electric scooter, motorcycle, or the like) and/or a pedestrian 116.

When scene perception is made, AV 102₁ performs operations to: generate one or more possible object trajectories for the detected object; and analyze at least one of the generated possible object trajectories to determine whether or not there is at least a threshold possibility or likelihood that a collision will occur between the AV and object if the AV is to follow a given trajectory. If not, the AV 102₁ is caused to follow the given vehicle trajectory. If so, the AV 102₁ is caused to (i) follow another vehicle trajectory with a relatively low probability of collision with the object or (ii) perform a maneuver to reduce the probability of collision with the object or avoid collision with the object (e.g., brakes and/or changes direction of travel).

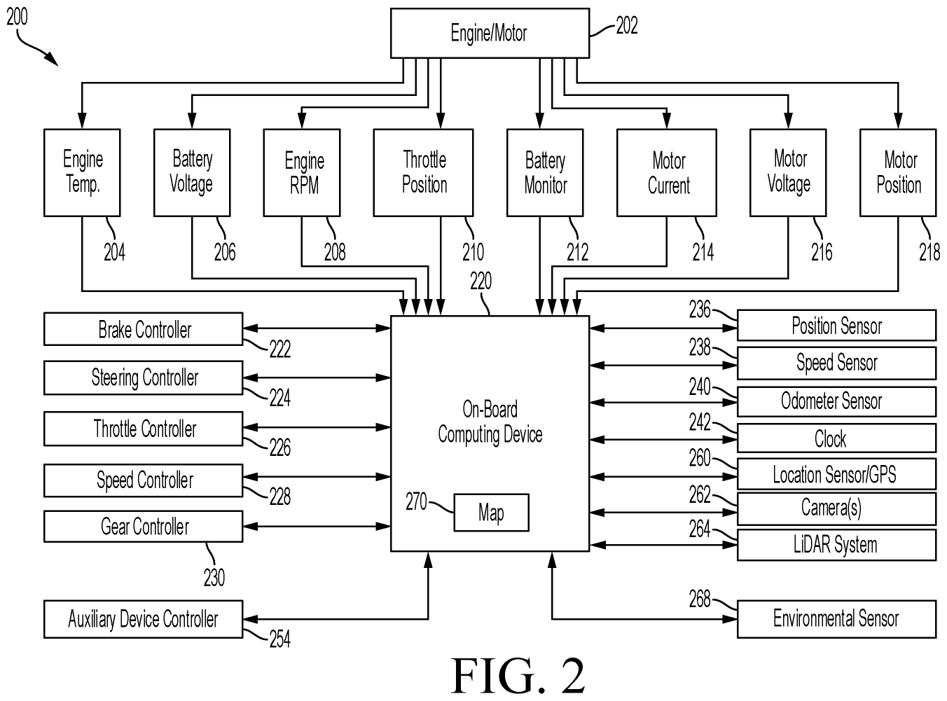

Referring now to FIG. 2, there is provided an illustration of an illustrative system architecture for a mobile platform 200. Mobile platforms 102₁, 102₂ and/or 120 of FIG. 1 can have the same or similar system architecture as that shown in FIG. 2. Thus, the following discussion of mobile platform 200 is sufficient for understanding mobile platform (s) 102₁, 102₂, 120 of FIG. 1.

As shown in FIG. 2, the mobile platform 200 includes an engine or motor 202 and various sensors 204-218 for measuring various parameters of the mobile platform. In gas-powered or hybrid mobile platforms having a fuel-powered engine, the sensors may include, for example, an engine temperature sensor 204, a battery voltage sensor 206, an engine Rotations Per Minute (RPM) sensor 208, and a throttle position sensor 210. If the mobile platform is an electric or hybrid mobile platform, then the mobile platform may have an electric motor, and accordingly will have sensors such as a battery monitoring system 212 (to measure current, voltage and/or temperature of the battery), motor current 214 and motor voltage 216 sensors, and motor position sensors such as resolvers and encoders 218.

Operational parameter sensors that are common to both types of mobile platforms include, for example: a position sensor 236 such as an accelerometer, gyroscope and/or inertial measurement unit; a speed sensor 238; and an odometer sensor 240. The mobile platform also may have a clock 242 that the system uses to determine mobile platform time during operation. The clock 242 may be encoded into an on-board computing device, it may be a separate device, or multiple clocks may be available.

The mobile platform also will include various sensors that operate to gather information about the environment in which the mobile platform is traveling. These sensors may include, for example: a location sensor 260 (e.g., a Global Positioning System (GPS) device); and image-based perception sensors such as one or more cameras 262. The sensors also may include environmental sensors 268 such as a precipitation sensor and/or ambient temperature sensor. The image-based perception sensors may enable the mobile platform to detect objects that are within a given distance range of the mobile platform 200 in any direction, while the environmental sensors collect data about environmental conditions within the mobile platform's area of travel.

During operations, information is communicated from the sensors to the on-board computing device 220. The on-board computing device 220 can (i) cause the sensor information to be communicated from the mobile platform to an external device (e.g., computing device 110 of FIG. 1) and/or (ii) use the sensor information to control operations of the mobile platform. For example, the on-board computing device 220 may control: braking via a brake controller 232; direction via a steering controller 224; speed and acceleration via a throttle controller 226 (in a gas-powered vehicle) or a motor speed controller 228 (such as a current level controller in an electric vehicle); a differential gear controller 230 (in vehicles with transmissions); and/or other controllers.

Geographic location information may be communicated from the location sensor 260 to the on-board computing device 220, which may then access a map of the environment that corresponds to the location information to determine known fixed features of the environment such as streets, buildings, stop signs and/or stop/go signals.

In some scenarios, the on-board computing device 220 detect a moving object and perform operations when such detection is made. For example, the on-board computing device 220 may generate one or more possible object trajectories for the detected object, and analyze the possible object trajectories to assess the risk of a collision between the object and the AV if the AV was to follow a given platform trajectory. If the risk does not exceed the acceptable threshold, then the on-board computing device 220 may cause the mobile platform 200 to follow the given platform trajectory. If the risk exceeds an acceptable threshold, the on-board computing device 220 performs operations to: (i) determine an alternative platform trajectory and analyze whether the collision can be avoided if the mobile platform follows this alternative platform trajectory; or (ii) causes the mobile platform to perform a maneuver (e.g., brake, accelerate, or swerve).

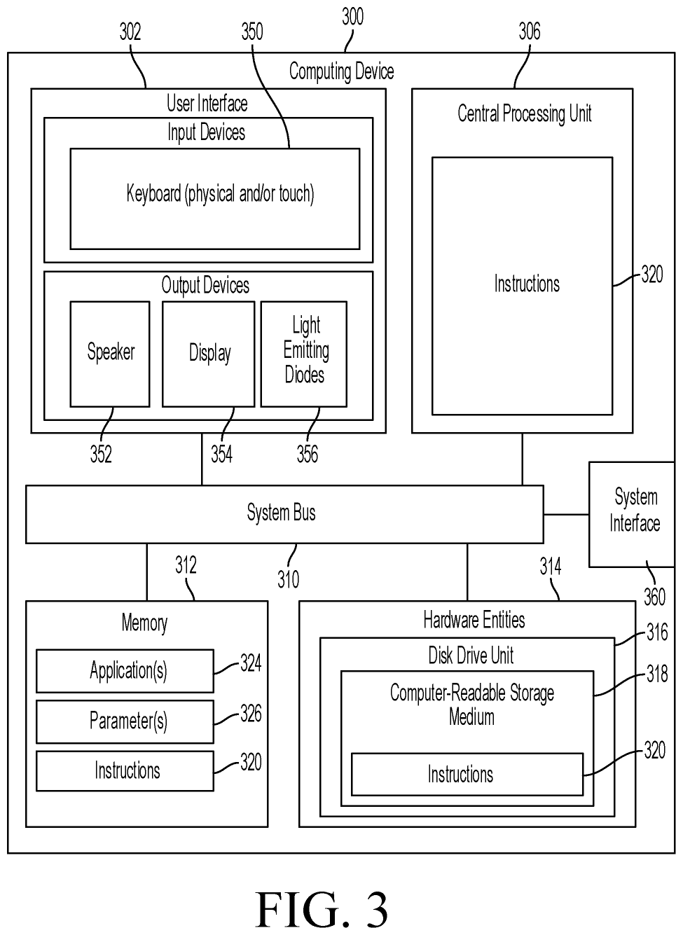

Referring now to FIG. 3, there is provided an illustration of an illustrative architecture for a computing device 300. The computing device 110 of FIG. 1 and/or the on-board computing device 220 of FIG. 2 is/are the same as or similar to computing device 300. As such, the discussion of computing device 300 is sufficient for understanding the computing device 110 of FIG. 1 and the on-board computing device 220 of FIG. 2.

Computing device 300 may include more or less components than those shown in FIG. 3. However, the components shown are sufficient to disclose an illustrative solution implementing the present solution. The hardware architecture of FIG. 3 represents one implementation of a representative computing device configured to operate a vehicle, as described herein. As such, the computing device 300 of FIG. 3 implements at least a portion of the method(s) described herein.

Some or all components of the computing device 300 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 3, the computing device 300 comprises a user interface 302, a Central Processing Unit (CPU) 306, a system bus 310, a memory 312 connected to and accessible by other portions of computing device 300 through system bus 310, a system interface 360, and hardware entities 314 connected to system bus 310. The user interface can include input devices and output devices, which facilitate user-software interactions for controlling operations of the computing device 300. The input devices include, but are not limited to, a physical and/or touch keyboard 350. The input devices can be connected to the computing device 300 via a wired or wireless connection (e.g., a Bluetooth® connection). The output devices include, but are not limited to, a speaker 352, a display 354, and/or light emitting diodes 356. System interface 360 is configured to facilitate wired or wireless communications to and from external devices (e.g., network nodes such as access points, etc.).

At least some of the hardware entities 314 perform actions involving access to and use of memory 312, which can be a Random Access Memory (RAM), a disk drive, flash memory, a Compact Disc Read Only Memory (CD-ROM) and/or another hardware device that is capable of storing instructions and data. Hardware entities 314 can include a disk drive unit 316 comprising a computer-readable storage medium 318 on which is stored one or more sets of instructions 320 (e.g., software code) configured to implement one or more of the methodologies, procedures, or functions described herein. The instructions 320 can also reside, completely or at least partially, within the memory 312 and/or within the CPU 306 during execution thereof by the computing device 300. The memory 312 and the CPU 306 also can constitute machine-readable media. The term “machine-readable media”, as used here, refers to a single medium or multiple media (e.g., a centralized or distributed database, and/or associated caches and servers) that store the one or more sets of instructions 320. The term “machine-readable media”, as used here, also refers to any medium that is capable of storing, encoding or carrying a set of instructions 320 for execution by the computing device 300 and that cause the computing device 300 to perform any one or more of the methodologies of the present disclosure.

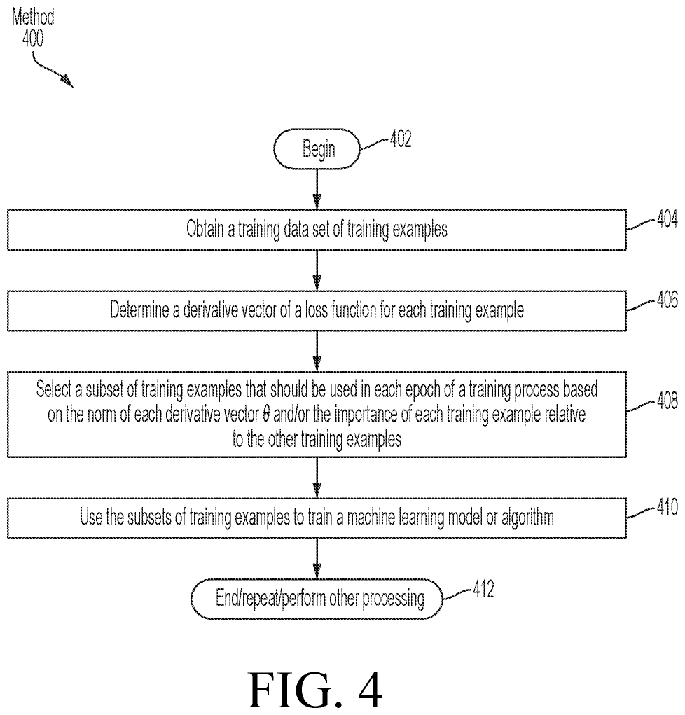

Referring now to FIG. 4, there is provided a flow diagram of an illustrative method 400 for training a machine learning model or algorithm (e.g., machine learning model/algorithm 128 of FIG. 1). Method 400 can be implemented in mobile platform 120 of FIG. 1, computing device 110 of FIG. 1 and/or computing device 300 of FIG. 3.

Method 400 begins with 402 and continues with 404 where a computing device obtains a training data set (e.g., training data set 126 of FIG. 1) from a datastore (e.g., datastore 112 of FIG. 1 and/or memory 312 of FIG. 3). The training data set comprises a plurality of training examples (x₀, y₀), (x₁, y₁), . . . , (xₙ, yₙ). As noted above, the training data set may be created using image(s) and/or other sensor data generated by one or more sensor(s) (e.g., sensors 130 of FIG. 1) on a mobile platform (e.g., mobile platform 120 of FIG. 1). The labels or ground truth values yᵢ may have been manually defined by a user (e.g., user 122 of FIG. 1) of the computing device for each data set xᵢ of the training examples.

Next in 406, a derivative vector θ of a loss function l_{θ}(x) is determined for each training example (xᵢ, yᵢ). Techniques for determining derivative vectors for loss functions are well known. In some scenarios, the loss function l_{θ}(x) involves comparing a true value yᵢ with a predicted value yₚ to obtain an output representing a distance (e.g., a Euclidean distance) between the true value yᵢ and the predicted value yₚ. The distance output by the loss function l_{θ}(x) should be small. The derivative vector θ may be randomly initialized for use in a first epoch e₀ in which a first subset of training examples s₀ is analyzed, and changed over all epochs e₁, . . . , e_{w} for the other subsets of training examples sᵢ, . . . , sₙ to iteratively improve the output of the loss function. The derivative vector θ may be changed in accordance with a known backpropagation algorithm in the direction of the derivative for the loss function (i.e., the direction of the steepest descent of the loss function). The backpropagation algorithm generally computes the gradient of the loss function with respect to the weights of the neural network for a set of input-output training examples, often called a training batch.

Upon completing 406, the computing device performs operations to select a subset of training examples that should be used in each epoch of the training process based on the norms of the derivative vectors θ associated with the training examples and/or the importance of each training example relative to the other training examples in the given training data set. The training example subset selection process is performed such that a total number of training examples in a subset for first epoch(s) (e.g., epochs e₀, e₁, . . . , e₅) is different (e.g., is less) than the total number of training examples in subsets for subsequent second epoch(s) (e.g., epochs e₆, e₇, . . . , e₂₀). The total number of training examples may be increased or otherwise varied for subsequent epochs. For example, five percent of the total training examples of data set x₁ are to be used in a first epoch e₀, while twenty percent of the total training examples of data set x₂ are to be used in a second subsequent epoch e₁, . . . , or e_{w}. These percentages can be predefined or dynamically determined based on a total number of training examples in each data set xᵢ and/or confidence values associated with labels of the training examples.

The training examples may be selected for inclusion in a subset sᵢ based on their rankings. The training examples can be ranked in accordance with the norms of their derivative vectors. The training examples with the greatest or best rankings are then selected for inclusion in the subset sᵢ. For example, M training examples of a training data set are selected which have the greatest or best ranking, and therefore are contained in a subset s₁. N training examples are selected which have the greatest or best ranking, and therefore are contained in a subset s₂. N may be the same as or different than M. In effect, only a subset of the training examples is used in each epoch as compared to prior art systems which use all training examples in every epoch. This feature of the present solution reduces computational time of the training process.

The subsets are then used in 410 to train the machine learning model or algorithm. Techniques for training machine learning models/algorithms using training data are known. Subsequently, 412 is performed where method 400 ends or other operations are performed (e.g., return to 402).

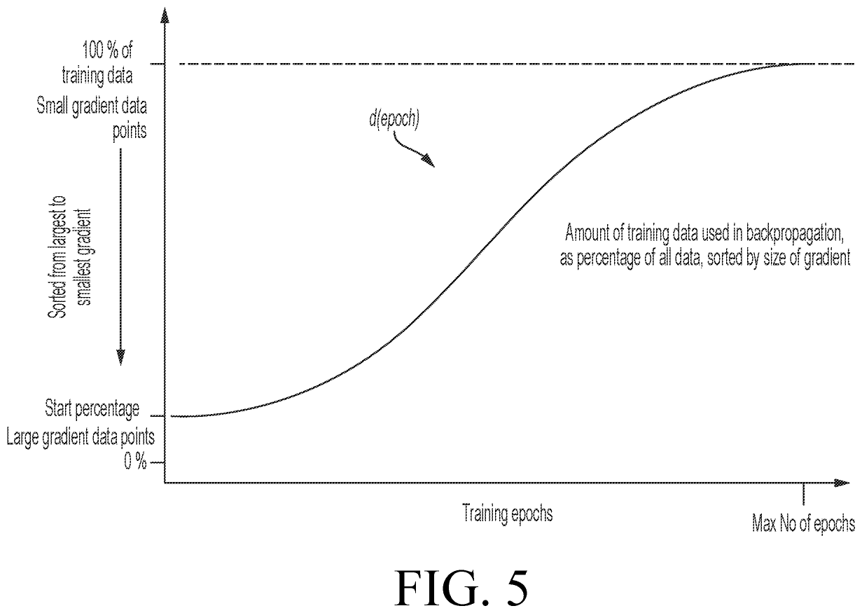

Referring now to FIG. 5, there is provided a graph that is useful for understanding the novel training process of the present solution. In order for the training process to work, certain design choices must be made. For example, the system must (i) know how many epochs are to be used for training a machine learning model or algorithm, (ii) know a starting percentage (e.g., 5%) of the training examples that should be used during a first epoch, and/or (iii) know a desired shape of the curve c(epoch). Another parameter that may be known by the system is the update frequency for the norm of the gradients for all training examples (e.g., every 5^{th} epoch).

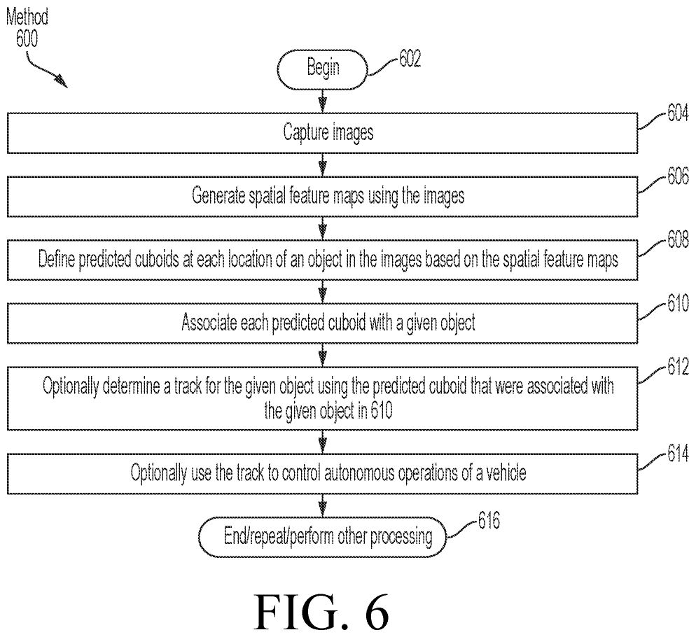

Referring now to FIG. 6, there is provided a flow diagram of a method 600 for image-based perception using machine learning model(s)/algorithm(s) which was(were) trained in accordance with method 400 discussed above. In method 600, the trained machine learning model(s)/algorithm(s) (such as a CNN or RNN) is(are) used to extract features from images. The features are used to predict 3D cuboids for objects in a scene. It can be challenging to determine if two or more cuboid predictions correspond to the same object from different cameras with overlapping FOVs. This is particularly challenging when only a partial view of an object is present in one or more cameras or when the cuboid estimates contain a relatively large amount of noise. Rather than rely solely on the estimated 3D coordinates when associating cuboids from multiple cameras, the machine learning model(s)/algorithm(s) is(are) trained to output a feature embedding that can be used for object-cuboid associations. This can be done by passing the intermediate features and camera calibration information in the region used for a cuboid's prediction through additional layers of computation (e.g., 2D convolutions and/or fully connected layers).

During the training process of FIG. 4, the intermediate feature embedding output by the machine learning model(s)/algorithm(s) can be passed into a loss function that encourages the embedding to have a small distance to embeddings for the same object from a different view, and a large distance from other objects. This can be accomplished via, for example, a triple loss algorithm.

As shown in FIG. 6, method 600 begins with 602 and continues with 604 where images are captured by a mobile platform (e.g., mobile platform 102₁ of FIG. 1) on which the trained machine learning model/algorithm has been deployed. The images can be captured by monocular cameras (e.g., cameras 262 of FIG. 2) with overlapping FOVs. Each image comprises 3 layers (or channels) of information superimposed on each other—a Red (R) layer, a Green (G) layer and a Blue (B) layer. This image may also be referred to as an RGB image. The images can be stored in a datastore local to and/or remote from the mobile platform (e.g., datastore 112 of FIG. 1 and/or memory 312 of FIG. 3).

In 606, spatial feature maps are generated by the computing device using the images captured in 604. The images can be used by the trained machine learning model/algorithm (e.g., a CNN) to generate the spatial feature maps. For example, images are input into a trained CNN to produce output spatial feature maps. The trained machine learning model/algorithm can apply filters or feature detectors to the images to produce the spatial feature maps. For example, a trained CNN takes an RGB image as an input, and optionally outputs the class of the 2D image (e.g., a person, a vehicle, a cyclist, a dog, etc.). The class of the image is determined based on learned data patterns during training of the CNN. Each spatial feature map indicates a location and a strength of each detected feature in an image. The features can include, but are not limited to, edges, vertical lines, horizontal lines, bends and/or curves. A certain combination of features in a certain area of an image can indicate that a larger, more complex feature may exist in the image. For example, a spatial feature map could detect a cyclist (e.g., cyclist 114 of FIG. 1) from a combination of line features and circle features in a given area of an image.

In 608, predicted cuboids are defined at each location of an object in the images based on the spatial feature maps. Each predicted cuboid comprises an orientated 3D box encompassing features that are associated with a given object. Techniques for defining predicted cuboids from spatial feature maps are well known. One such known technique that can be employed in 608 is using linear regression of the feature's 3D coordinates to learn edges of an object in an image and using the edges to define a predicted 3D cuboidal shape for the object. The predicted 3D cuboidal shape defined for the object is referred to as a predicted cuboid. Such known techniques can be used in 608.

In 610, each predicted cuboid is associated with a given object. This association can be generally made by: determining whether two or more of the predicted cuboids should be associated with a same detected object; and assigning the predicted cuboids to detected objects based on results of the determinations. The assignment can be made, for example, by storing object identifiers in a datastore to be associated with the predicted cuboids.

In some scenarios, the determination as to whether predicted cuboids should be associated with the same object is made by generating a feature embedding from a region of the spatial feature maps for each predicted cuboid. The parameters for generating these feature embeddings can be learned via, for example, a triplet or quadruplet loss algorithm. The embeddings are then used to obtain values for the visual features of each object in the images. These visual feature values are compared to each other to determine whether they are the same as each other by a certain amount or degree (e.g., 70% or the difference between two visual feature values is less than a threshold value). The generation of an additional embedding trained with, for example, a triplet loss algorithm addresses different angles of the objects and any occlusion of the objects. The feature embedding can be generated by applying a function (e.g., a 2D convolution function) point-wise to each point of the spatial feature map included in the predicted cuboid so as to transform the same to a data point feature embedding (e.g., visual descriptor of what the object is). Thus, the term “feature embedding” as used herein refers to a vector representation of visual and spatial features extracted from an image.

Triplet loss algorithms are well known. The triplet loss function is a machine learning algorithm where, during training, a baseline input is compared to a positive input and a negative input. The distance from the baseline input to the positive input is minimized, and the distance from the baseline input to the negative input is maximized. The triplet loss algorithm can be described using a Euclidean distance function as shown by the following mathematical equation (1).

[symbol]

(A,P,N)=max(∥f(A)−f(P)∥²−∥f(A)−f(N)∥²+α,0) (1)

where A is an anchor input, P is a positive input of a same class as A, N is a negative input of a different class as A, α is a margin between positive and negative pairs, and f is a feature embedding.

Next, the computing device determines a difference between each set of two feature embeddings. For example, an L1 or L2 distance function can be used to determine this difference. The L1 distance function may be defined by the following mathematical equation (2).

$$L 1 = {\sum }_{i = 1}^{n} \vert {y}_{true} - {y}_{predicted} \vert \qquad ( 2 )$$

where L1 represents results from performing the L1 distance function, y₁ represents an embedding derived from one feature map, and y₂ represents an embedding derived from a second feature map. The L2 distance function may be defined by the following mathematical equation (3).

$$L 2 = {\sum }_{i = 1}^{n} {( {y}_{true} - {y}_{predicted} )}^{2} \qquad ( 3 )$$

where L2 represents results from performing the L2 distance function.

The computing device also determines a difference between coordinates of each set of predicted cuboids. Methods for determining differences between coordinate are well known. If the differences are less than respective threshold values, then the computing device concludes that the predicted cuboids should be associated with the same object. If the differences are less than the respective threshold values, then computing device concludes that the predicted cuboids should not be associated with the same object.

Once the object-cuboid associations have been made in 610 of FIG. 6, a track for a given object is optionally determined in 614. Techniques for determining object tracks based on predicted cuboids are well known. The object track is then optionally used in 616 to control autonomous operations of the mobile platform. For example, the predicted cuboids are used to determine a track for the respective object. The object track can then be used to facilitate generation of a platform trajectory which the mobile platform is caused to follow. Subsequently, 618 is performed where method 600 ends or other operations are performed.

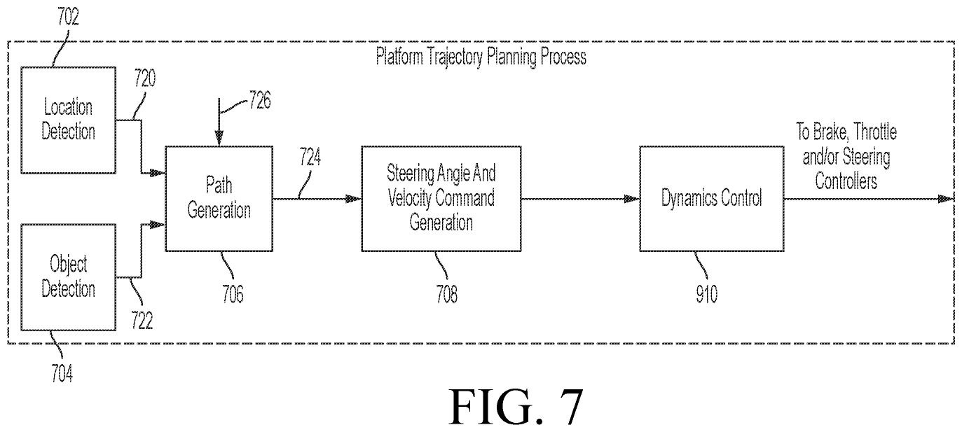

The predictions (e.g., cuboids) generated during method 600 can be used by a mobile platform for object trajectory prediction, general scene understanding, platform trajectory generation, and/or collision avoidance. A block diagram is provided in FIG. 7 that is useful for understanding how platform control is achieved in accordance with the object related information estimated based on the modified image. All or some of the operations performed in FIG. 7 can be performed by the on-board computing device of a mobile platform (e.g., AV 102₁ of FIG. 1) and/or a remote computing device (e.g., computing device 110 of FIG. 1).

In block 702, a location of the mobile platform is detected. This detection can be made based on sensor data output from a location sensor (e.g., location sensor 260 of FIG. 2) of the mobile platform. This sensor data can include, but is not limited to, GPS data. Information 720 specifying the detected location of the mobile platform is then passed to block 706.

In block 704, an object is detected within proximity of the mobile platform. This detection is made based on sensor data output from a camera (e.g., camera 262 of FIG. 2) of the mobile platform and/or LiDAR datasets generated by a LiDAR system (e.g., LiDAR system 264 of FIG. 2) of the mobile platform. The manner in which the image-based perception is achieved was discussed above in relation to FIG. 6. Image-based perception information 722 about the detected object is passed to block 706. This information includes, but is not limited to, cuboid information (e.g., a position of an object, an orientation of the object, and a spatial extent of the object), an initial predicted trajectory of the object, a speed of the object, and/or a classification of the object. The initial predicted object trajectory can include, but is not limited to, a linear path pointing in the heading direction of the object.

In block 706, a platform trajectory is generated using the information from blocks 702 and 704. Techniques for determining a platform trajectory are well known in the art. Any known or to be known technique for determining a platform trajectory can be used herein without limitation. For example, in some scenarios, such a technique involves determining a trajectory for the mobile platform that would pass the object when the object is in front of the mobile platform, the object has a heading direction that is aligned with the direction in which the mobile platform is moving, and the object has a length that is greater than a threshold value. The present solution is not limited to the particulars of this scenario. The platform trajectory 724 can be determined based on the information 720, the image-based perception information 722, and/or a road map 726 which is pre-stored in a datastore of the mobile platform. The platform trajectory 724 may represent a smooth path that does not have abrupt changes that would otherwise provide passenger discomfort. For example, the platform trajectory is defined by a path of travel along a given lane of a road in which the object is not predicted travel within a given amount of time. The platform trajectory 724 is then provided to block 708.

In block 708, a steering angle and velocity command is generated based on the platform trajectory 724. The steering angle and velocity command are provided to block 710 for dynamics control.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. A method for training a machine learning model, comprising:
obtaining, by a computing device, a training data set comprising a collection of training examples, each training example comprising at least one data point;
selecting, by the computing device, a first subset of training examples from the collection of training examples based on at least one of a derivative vector of a loss function for each training example of the collection of training examples and an importance of each training examples relative to other training examples in the collection of training examples; and
training, by the computing device, the machine learning model using the first subset of training examples;
wherein a total number of training examples in the first subset is unequal to a total number of training examples in the training data set.

2. The method according to claim 1, further comprising using the machine learning model which has been trained to control operations of a mobile platform.

3. The method according to claim 1, wherein the at least one data point is obtained from an image generated by a camera.

4. The method according to claim 1, wherein the first subset of training examples is selected based on a norm of the derivative vector.

5. The method according to claim 1, wherein each said training example further comprises a true value for a property to be predicted by the machine learning model.

6. The method according to claim 1, further comprising selecting, by the computing device, a second subset of training examples based on at least one of a derivative vector of the loss function for each training example of the collection of training examples and an importance of each training examples relative to the other training examples in the collection of training examples.

7. The method according to claim 6, wherein the first subset of training examples is used in a first epoch in said training and the second subset of training examples is used in a second epoch of said training.

8. The method according to claim 6, wherein a total number of training examples in the second subset is different than the total number of training examples in the first subset.

9. The method according to claim 1, further comprising ranking the plurality of training examples in accordance with norms of the derivative vectors of the loss function.

10. A system, comprising:
a processor;
a non-transitory computer-readable storage medium comprising programming instructions that are configured to cause the processor to implement a method for training a machine learning model, wherein the programming instructions comprise instructions to:
obtain a training data set comprising a collection of training examples, each training example comprising at least one data point;
select a first subset of training examples from the collection of training examples based on at least one of a derivative vector of a loss function for each training examples in the collection of training examples and an importance of each training examples of the collection of training examples relative to other training examples of the collection of training examples; and
train the machine learning model using the first subset of training examples;
wherein a total number of training examples in the first subset is unequal to a total number of training examples in the collection of training examples.

11. The system according to claim 10, wherein the programming instructions further comprise instructions to cause the machine learning model which has been trained to control operations of a mobile platform.

12. The system according to claim 10, wherein the at least one data point is obtained from an image generated by a camera.

13. The system according to claim 10, wherein the first subset of training examples is selected based on a norm of the derivative vector.

14. The system according to claim 10, wherein each said training example further comprises a true value for a property to be predicted by the machine learning model.

15. The system according to claim 10, wherein the programming instructions further comprise instructions to select a second subset of training examples based on at least one of a derivative vector of the loss function for each training example of the collection of training examples and an importance of each training examples relative to the other training examples of the collection of training examples.

16. The system according to claim 15, wherein the first subset of training examples is used in a first epoch in said training and the second subset of training examples is used in a second epoch of said training.

17. The system according to claim 15, wherein a total number of training examples in the second subset is different than the total number of training examples in the first subset.

18. The system according to claim 10, wherein the programming instructions further comprise instructions to rank the plurality of training examples in accordance with norms of the derivative vectors of the loss function.

19. A computer program product comprising a memory and programming instructions that are configured to cause a processor to:
obtain a training data set comprising a collection of training examples, each training example comprising at least one data point;
select a first subset of training examples from the collection of training examples based on at least one of a derivative vector of a loss function for each training example in the collection of training examples and an importance of each training examples relative to other training examples of the collection of training examples; and
train the machine learning model using the first subset of training examples;
wherein a total number of training examples in the first subset is unequal to a total number of training examples in the collection of training examples.

20. The computer program product according to claim 19, wherein the programming instruction are further configured to cause the processor to use or instruct an external device to use the machine learning model which has been trained to control operations of a mobile platform.
